(19) United States
(12) Patent Application Publication
(10) Pub. No.: US 2021/0253891 A1
(43) Pub. Date: Aug. 19, 2021

(54) SURFACE COATING COMPOSITION AND METHOD OF MAKING THE SAME

(71) Applicant: IPS Corporation, Compton, CA (US)

(72) Inventor: Marc Phillip Rosenthal, Gilroy, CA (US)

(21) Appl. No.: 17/174,602

(22) Filed: Feb. 12, 2021

Related U.S. Application Data
(60) Provisional application No. 62/976,011, filed on Feb. 13, 2020.

(51) Int. Cl. C09D 133/08

(52) U.S. Cl. CPC C09D 133/08; C08K 2003/265

(57) ABSTRACT

A coating composition for coating a surface, such as a roof, includes an acrylic polymer, water, ammonia, and a curing agent configured to reduce a curing time for the coating composition when applied to the surface. The coating composition further includes an odor mitigator configured to reduce an odor of the coating composition resulting from the ammonia.

### CROSS-REFERENCE TO RELATED APPLICATIONS

This application claims priority, under 35 U.S.C. § 119, to U.S. provisional application 62/976,011 filed on Feb. 13, 2020, the entire contents of which are incorporated herein by reference.

### TECHNICAL FIELD

Embodiments discussed herein generally relate to improved coating compositions for surfaces, such as roofs, and to methods for making such coating compositions. More specifically, embodiments discussed herein generally relate to surface coating compositions exhibiting early rain resistance, reduced odors, and reduced cure times.

### BACKGROUND

Acrylic-based coating formulations may be applied to exterior surfaces, such as roofs or other architectural surfaces, as weather or waterproof sealants or coatings. Such coating formulations are aqueous dispersions of polymers and other additives, and are low in volatile organic compounds (VOCs). Being white in color, these coatings may act as a solar barrier and protect exterior surfaces from wear and tear by reflecting heat and ultraviolet (UV) rays from sunlight. This may reduce heat transfer into the building, significantly decrease building cooling costs, and provide energy savings.

Acrylic-based coating formulations may be applied to a surface by a suitable coating technique, and subsequently allowed to dry and cure on the surface to form a coating. When curing, the coating formulations form hardened films by a process of coalescence during which the water evaporates, the coating volume is reduced, and the particles in the dispersion are forced closer together to eventually form a solid network on the surface. As the curing process depends on water evaporation, coating curing times may be significantly faster in high temperature and low humidity weather conditions. When outside temperatures are low and/or humidity is high, acrylic-based coatings may suffer from prolonged curing times, poor coating quality, or even wash-off if rainfall occurs during or after the coating application. Consequently, it may be challenging to provide durable coatings in unfavorable weather conditions, during certain times of the year, or in geographical regions that frequently experience low temperatures and/or high humidity. In addition, to achieve desired coating thicknesses, more than one coating layer may be used, with each coating layer taking hours to dry before the next layer can be applied. This further exacerbates the challenge in finding a suitable window when weather conditions are favorable for the coating application.

To overcome the above drawbacks, additives have been introduced into acrylic-based coatings to increase curing rates such that the applied coatings set quickly and resist rain wash-off. For instance, WO 2014/060456 describes the use of derivatized polyamines as curing agents that substantially decrease curing times in acrylic-based coatings. Due to the decreased curing times, the resulting coatings exhibit high early rain resistance, which is a measure of a coating's ability to withstand rain wash-off after application to a surface. While effective, the curing agent may reduce the shelf life of the coating formulations considerably due to faster setting/solidification during storage. Furthermore, the coating formulations include ammonia to raise the pH and activate the curing agent. The ammonia produces a strong and unpleasant odor for crew or building occupants during the coating application process.

Accordingly, there is a need for improved acrylic-based coating formulations that exhibit early rain resistance, reduced cure times, and reduced odors. The embodiments of the present disclosure attempt to provide a technical solution to address these needs.

### SUMMARY

Embodiments disclosed herein relate to acrylic-based coating compositions that provide a technical solution to the above challenges. In one embodiment, a coating composition for coating a surface may include an acrylic-based resin, water, a volatile base producing an odor, and a curing agent configured to reduce a curing time for the coating composition when applied to the surface. The coating composition may further include an odor mitigator configured to reduce an odor of the coating composition resulting from the volatile base.

In another embodiment, a coating composition for coating a surface may include an acrylic-based resin, water, ammonia, and from about 0.5% to about 5% by weight of a curing agent configured to reduce a curing time of the coating composition when applied to the surface. The coating composition may further include an odor mitigator configured to reduce an odor of the coating composition.

In another embodiment, a method of formulating a surface coating composition may include formulating a base coating composition that at least includes an acrylic-based resin and water. The method may further include adjusting a pH of the base coating composition to above 10.8 by adding and mixing aqueous ammonia into the base coating composition, and adding and mixing from about 0.5% to about 5% by weight of a curing agent into the base coating composition after adjusting the pH of the base coating composition. The curing agent may be configured to reduce a curing time for the coating composition when applied to the surface. The curing agent may include one or more derivatized polyamines having one or more amine groups derivatized with a non-hydrogen moiety (R). In addition, the method may further comprise adding and mixing an odor mitigator into the base coating composition to provide the surface coating composition. The odor mitigator may be configured to reduce an odor of the surface coating composition.

### BRIEF DESCRIPTION OF THE DRAWINGS

FIG. 1 is a flowchart illustrating a series of steps that may be involved in formulating a surface coating composition, according to one embodiment.

### DETAILED DESCRIPTION

The present disclosure provides improved quick-curing, acrylic-based surface coating compositions with reduced odors and faster cure times. The surface coating compositions disclosed herein may be applied to various types of exterior surfaces for weatherproofing, waterproofing, heat reflection, and/or solar protection. Suitable exterior surfaces may include, but are not limited to, low slope roofs, parapets, edges, and insulation surfaces. The surfaces coated by the coating compositions disclosed herein may be formed from various types of materials such as, but not limited to, metal, asphalt, concrete, brick, stone, wood, glass, polymers, polyurethane, composite materials, and combinations thereof. The surface coating compositions resist rain wash-off after curing under low temperature and high humidity conditions. For example, in some embodiments, the surface coating compositions cure quickly and exhibit rain wash-off resistance at 40° F. and 80% relative humidity when applied to surfaces. This allows crew to complete a coating assignment faster, and under a wider window of weather conditions. Furthermore, the reduced odor greatly improves the working conditions for the crew, and reduces unpleasantness for building occupants or neighbors during the coating application process.

The surface coating composition at least includes:

(a) an acrylic-based resin;

(b) water;

(c) a volatile base that produces an odor;

(d) a curing agent that reduces a curing time for the coating composition when applied to the surface;

(e) an odor mitigator configured to reduce an odor of the coating composition resulting from the volatile base.

In some embodiments, the surface coating composition further includes (f) fillers and biocides and, optionally (g) one or more additives and/or pigments.

As used herein, an acrylic-based resin includes a polymer or a copolymer at least partially derived from one or more acrylate monomers. The acrylic-based resin may be a pure acrylic polymer (i.e., a polymer or copolymer derived exclusively from one or more acrylate monomers), a styrene-acrylic polymer (i.e., a copolymer derived from styrene and one or more acrylate monomers), or a vinyl-acrylic monomer (i.e., a copolymer derived from one or more vinyl ester monomers and one or more acrylate monomers). In some embodiments, the acrylic-based resin may be an anionically-stabilized copolymer derived from acrylate monomers and one or more ethylenically-unsaturated monomers such as, but not limited to, vinyl aromatic monomers (e.g., styrene), ethylenically unsaturated aliphatic monomers (e.g., butadiene), and vinyl ester monomers (e.g., vinyl acetate). In some embodiments, the anionically-stabilized copolymer may be derived from one or more acrylate monomers, one or more carboxylic acid-containing monomers, optionally one or more acetoacetoxy monomers, optionally one or more phosphorus-containing monomers, and optionally one or more additional ethylenically-unsaturated monomers. In such embodiments, the anionically-stabilized copolymer may be derived from greater than 55% by weight one or more acrylate monomers. For example, the anionically-stabilized copolymer may be derived from greater than 80% by weight one or more acrylate monomers.

Exemplary acrylate monomers include, but are not limited to, methyl acrylate, methyl (meth)acrylate, ethyl acrylate, ethyl (meth)acrylate, butyl acrylate, butyl (meth)acrylate, isobutyl (meth)acrylate, n-hexyl (meth)acrylate, ethylhexyl (meth)acrylate, n-heptyl (meth)acrylate, ethyl (meth)acrylate, 2-methylheptyl (meth)acrylate, octyl (meth)acrylate, isooctyl (meth)acrylate, n-nonyl (meth)acrylate, isononyl (meth)acrylate, n-decyl (meth)acrylate, isodecyl (meth)acrylate, dodecyl (meth)acrylate, lauryl (meth)acrylate, tridecyl (meth)acrylate, stearyl (meth)acrylate, glycidyl (meth)acrylate, alkyl crotonates, vinyl acetate, di-n-butyl maleate, di-octylmaleate, acetoacetoxyethyl (meth)acrylate, acetoacetoxypropyl (meth)acrylate, hydroxyethyl (meth)acrylate, allyl (meth)acrylate, tetrahydrofurfuryl (meth)acrylate, cyclohexyl (meth)acrylate, 2-ethoxyethyl (meth)acrylate, 2-methoxy (meth)acrylate, 2-(2-ethoxyethoxy)ethyl (meth)acrylate, 2-ethylhexyl (meth)acrylate, 2-propylheptyl (meth)acrylate, 2-phenoxyethyl (meth)acrylate, isobornyl (meth)acrylate, caprolactone (meth)acrylate, polypropyleneglycol mono(meth)acrylate, polyethyleneglycol (meth)acrylate, benzyl (meth)acrylate, 2,3-di(acetoacetoxy)propyl (meth)acrylate, hydroxypropyl (meth)acrylate, methylpolyglycol (meth)acrylate, 3,4-epoxycyclohexylmethyl (meth)acrylate, 1,6 hexanediol di(meth)acrylate, 1,4 butanediol di(meth)acrylate, and combinations thereof.

In one specific embodiment, the acrylic-based resin contains a pure acrylic polymer (i.e., a polymer or a copolymer derived exclusively from acrylate monomers). In this embodiment, the acrylic-based resin is a white colored dispersion containing about 55% by weight solids, and has a glass transition temperature (T_{g}) of −28° C. when applied to a surface as a film.

The volatile base may be incorporated into the surface coating composition to raise the pH of the coating composition in order to activate the curing agent. In one specific embodiment, the volatile base is ammonia. Other exemplary volatile bases may include, but are not limited to, dimethylamine, triethylamine, diethylamine, ethanolamine, diethanolamine, triethanolamine, morpholine, aminopropanol, 2-amino-2-methyl-1-propanol, 2-dimethylaminoethanol, and combinations thereof. In some embodiments, the coating composition may include 0.2% to 5% by weight of the volatile base. For instance, the coating composition may contain about 2-3% by weight of the volatile base in one specific embodiment.

The curing agent may include one or more derivatized polyamines that reduce the curing or setting time of the coating composition when applied to the surface. Suitable derivatized polyamines are described in US patent application publication number 2015/0259559A1 and International publication number WO 2014/060456A2, which are incorporated herein by reference. The polyamines may contain a plurality of primary amine groups, secondary amine groups, or combinations thereof. The polyamine may be a polymer or copolymer derived from one or more monomers containing an amine group. Suitable monomers of this type include vinylamine, allylamine, and ethyleneimine. Other suitable amino-containing monomers include (meth)acrylate monomers containing one or more primary and/or secondary amine groups, such as 2-aminoethyl methacrylate, 2-aminoethyl acrylate, 2-(tert-butylamino)ethyl acrylate, 2-(tert-butylamino)ethyl methacrylate. In some embodiments, the polyamine is an acrylic polymer derived from one or more monomers comprising an amino group.

As used herein, a derivatized polyamine is a polyamine in which one or more primary or secondary amine groups have been covalently modified to replace one or more hydrogen atoms with a non-hydrogen moiety (R). In some embodiments, each R within the derivatized polyamine is individually selected from the group consisting of a C1-6 alkyl group, optionally substituted with one or more hydroxyl groups; an acyl group (—COR1), wherein R1 is a C1-C6 alkyl group or a C5-C7 aryl or heteroaryl group, optionally substituted with one or more hydroxyl groups; (—COOR2), wherein R2 is a C1-C6 alkyl group or a C5-C7 aryl or heteroaryl group, optionally substituted with one or more hydroxyl groups; (—SO₂R3), wherein R3 is a C1-C6 alkyl group or a C5-C7 aryl or heteroaryl group, optionally substituted with one or more hydroxyl groups, and a poly(alkylene oxide) group. The R groups present within a derivatized polyamine can be selected such that the derivatized polyamine possesses a hydrophilicity which renders the derivatized polyamine compatible with aqueous coating compositions. For example, the R groups within the derivatized polyamine can be selected such that the derivatized polyamine is water soluble or water dispersible. In some embodiments, at least 50% of the derivatized amine groups are alkoxylated amine groups.

In some embodiments, the derivatized polyamine includes alkoxylated polyamine groups. Suitable alkoxylated polyamines include alkoxylated polyamines derived from 2 to 8 carbon alkylene oxides. In some embodiments, the alkoxylated polyamine is derived from ethylene oxide, propylene oxide, butylene oxide, or combinations thereof. In particular embodiments, the alkoxylated polyamine is an alkoxylated polyalkyleneimine, an alkoxylated polyvinylamine, or a combination thereof. Suitable alkoxylated polyamines may also include ethoxylated polyethyleneimine, a propoxylated polyethyleneimine, a butoxylated polyethyleneimine, or a combination thereof. Suitable alkoxylated polyvinylamines include those described in U.S. Pat. No. 7,268,199 to Andre, et al., which is incorporated herein by reference for its teaching of alkoxylated polyvinylamines. Suitable alkoxylated polyalkyleneimines, as well as methods of making thereof, are also known in the art. See, for example, U.S. Pat. No. 7,736,525 to Thankachan, et al., U.S. Pat. No. 6,811,601 to Borzyk, et al., and WO 99/67352, all of which are incorporated herein by reference for their teaching of alkoxylated polyalkyleneimines.

In some embodiments, the derivatized polyamine includes an alkylated polyalkyleneimine (e.g., an alkylated polyethyleneimine or an alkylated polyvinylamine), a hydroxyalkylated polyalkyleneimine (e.g., a hydroxalkylated polyethyleneimine or a hydroxyalkylated polyvinylamine), an acylated polyalkyleneimine (e.g., an acylated polyethyleneimine or an acylated polyvinylamine), or a combination thereof. In some embodiments, the derivatized polyamine may include a derivatized polyalkylene imine or an alkoxylated polyvinlyamine. The derivatized polyalkylene imine may include alkoxylated polyethylene imine (PEI).

The derivatized polyamine may have a degree of nitrogen-derivatization, defined as the percentage of available nitrogens within the polyamine that have been covalently modified to replace one or more hydrogen atoms with a non-hydrogen moiety, of at least 5%. In certain embodiments, the derivatized polyamine has a degree of nitrogen-derivatization between 5% and 95%. In certain embodiments, the derivatized polyamine has a degree of nitrogen-derivatization between 50% and 95% or between 70% and 90%. In embodiments where the derivatized polyamine is an alkoxylated polyamine, the degree of nitrogen-derivatization can be referred to as the degree of nitrogen alkoxylation, defined as the percentage of available nitrogens within the polyamine that have been converted to a corresponding hydroxyalkyl group.

The derivatized polyamine may have an average molecular weight of greater than 500 Daltons to less than 5,000,000 Daltons. For example, the derivatized polyamine may have an average molecular weight of between 40,000 Daltons and 150,000 Daltons. In one specific embodiment, the curing agent is Quick-Trigger® 4333 (hereinafter, “Quick-Trigger”) commercially available from BASF.

In some embodiments, the coating composition may include 10% or less by weight of the curing agent. For example, the coating composition may include from about 0.5% to about 6% by weight of the curing agent. In one specific embodiment tailored for low temperature/high humidity coating application conditions (40° F./80% relative humidity), the coating composition may include about 4% by weight of the curing agent.

The odor mitigator may be a fragrance that reduces an odor of the coating composition resulting at least from the volatile base. The odor mitigator may have a neutral fragrance without a distinctive scent, although it may have a detectable scent in some embodiments. The odor mitigator may be a mixture of hydrocarbons, esters, alcohols, and aldehydes. In one embodiment, the odor mitigator is a “neutral type” fragrance commercially available from Alpha Aromatics (hereinafter, “neutral type fragrance”). The odor mitigator may be a blend of eucalyptus oil, 3-phenyl-2-propenal, (1S, 5S)-2,6,6-trimethylbicyclo[3.1.1]hept-2-ene, cymbopogon nardus oil, α,α,4-trimethyl-3-cyclohexene-1-methanol, 2H-1-benzopyran-2-one, and 4,5,6-trimethylcyclohex-3-ene-1-carbaldehyde.

In an alternative embodiment, the odor mitigator may be a plant-based odor eliminator, such as Neutralene®7030 SF commercially available from AirCare Technologies or a comparable product. In this embodiment, the odor mitigator may include a blend of essential oils and compounds including eucalyptus oil (0-2.5% by weight), fragrance blend (3-7% by weight), cinnamaldehyde (less than 1% by weight), citrus distillate (less than 1% by weight), methyl cinnamaldehyde (less than 1% by weight), citronellal (less than 1% by weight), and 2-propanol (less than 1% by weight).

In another alternative embodiment, the odor mitigator may be KOR4G (Kill Odor) from Chemspec or a comparable product. In this embodiment, the odor mitigator may include ethoxylated and/or propoxylated C6-C12 alcohols (2.5-10% to 10% by weight) and ethoxylated and/or propoxylated C10-C16 alcohols (1-2.5% by weight) as surfactants, as well as other ingredients including surfactants, preservatives, fragrances, dyes, solvent, and water as diluent.

The coating composition may include 5% by weight or less of the odor mitigator. In some embodiments, the coating composition may include from about 0.05% to about 0.5% by weight of the odor mitigator. In one specific embodiment tailored for low temperature/high humidity coating application conditions (40° F./80% relative humidity), the coating composition includes about 4% by weight of the curing agent, and about 0.2% by weight of the neutral type fragrance odor mitigator.

Additionally, the surface coating composition may further include one or more fillers and one or more pigments. Exemplary fillers include, but are not limited to, calcium carbonate, nepheline syenite, feldspar, diatomaceous earth, talc, aluminosilicates, silica, alumina (aluminum oxide), clay, kaolin, mica, pyrophyllite, perlite, barium sulfate, calcium metasilicate, and combinations thereof. Non-limiting examples of pigments include metal oxides, such as titanium dioxide, zinc oxide, iron oxide, and combinations thereof. In some embodiments, the surface coating composition may include from about 30% to about 50% by weight of the fillers and pigments.

Other additives may also be included, such as dispersants, coupling agents, defoamers, plasticizers, coalescents, surfactants, rheology modifiers, co-solvents, and combinations thereof. In some embodiments, the coating composition may include less than 10% by weight of such additives. In one embodiment, the coating composition may include from about 1% to about 5% by weight of total additives.

Dispersants may serve to improve separation of particles and prevent clumping. Non-limiting examples of dispersants include potassium tripolyphosphate, polycarboxylate, polyacid dispersants, and hydrophobic copolymer dispersants. Defoamers may serve to minimize frothing during mixing and/or application of the coating composition. Suitable defoamers include, but are not limited to, paraffin, polysiloxanes, polydimethylsiloxanes, polyether modified polysiloxanes, and combinations thereof. Suitable plasticizers may include, for example, propylene glycol or other glycols. A suitable rheology modifier may include, for example, cellulose.

Coalescents may aid film formation during drying. Suitable coalescing agents may include, but are not limited to, Texanol™ ester alcohol, ethylene glycol monomethyl ether, ethylene glycol monobutyl ether, ethylene glycol monoethyl ether acetate, ethylene glycol monobutyl ether acetate, diethylene glycol monobutyl ether, diethylene glycol monoethyl ether acetate, dipropylene glycol monomethyl ether, 2,2,4-trimethyl-1,3-pentanediol monoisobutyrate, and combinations thereof. Suitable surfactants may include nonionic surfactants, anionic surfactants, cationic surfactants, and combinations thereof.

In some embodiments, the surface coating composition may further include one or more biocides to prevent spoilage of the coating composition in liquid form, and/or to prevent algeal and/or fungal growth in the coating composition when cured. In some embodiments, the coating composition may include from about 0.2% to about 2% by weight of the one or more biocides. For example, the coating composition may include from about 0.3% to about 1.5% by weight of the one or more biocides.

Table 1 below provides a surface coating composition in accordance with the present disclosure. It will be understood that the surface coating composition of Table 1 is merely exemplary, and that the weight percentage ranges of each ingredient may vary in practice.

TABLE 1
Exemplary Surface Coating Composition

| Ingredient | % by weight |
|---|---|
| acrylic-based resin | 30-40% |
| water | 10-20% |
| volatile base | 0.2-3% |
| curing agent | 0.5-6% |
| odor mitigator | 0.05-0.5% |
| fillers, pigments | 30-50% |
| additives (dispersants, coupling agents, | 1-5% |
| defoamers, plasticizers, coalescents, | |
| surfactants, rheology modifiers, co- | |
| solvents, etc.) | |
| biocides | 0.2-1.5% |

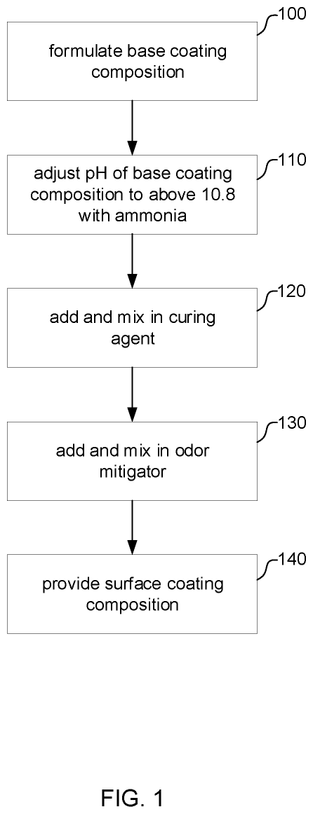

An exemplary method of manufacturing the surface coating composition is shown in FIG. 1. At a first block 100, a base coating composition is formulated. The base coating composition may include the acrylic-based resin, water, fillers, biocides, and optional pigments and/or additives. At a next block 110, the pH of the base coating composition may be adjusted to above 10.8 by adding and mixing in a suitable quantity of aqueous ammonia. This step may involve adding and mixing in aqueous ammonia into the base coating composition until the pH of the base coating composition is 10.8 or higher, as measured using a pH meter, pH paper, or other pH measuring system. With the pH suitably adjusted to 10.8 or higher, the curing agent may be added and mixed into the base coating composition according to a next block 120. The odor mitigator may be added and mixed into the base coating composition at a next block 130 to provide the surface coating composition (block 140). In some embodiments, the odor mitigator may be added to the base composition before the curing agent is added.

The coating composition thus formulated may be applied to a target exterior surface (roof, parapet, edge, etc.) using a suitable coating technique (e.g., brushing, spraying, rolling), and subsequently allowed to dry and cure on the surface to form a protective membrane. As explained above, the curing agent decreases the cure period for the coating composition, and prevents damage/wash off of the coating after rainfall under low temperature/high humidity conditions.

### Test Results

A series of coating compositions were prepared using acrylic resin with and without the neutral type fragrance odor mitigator, and varying amounts of curing agent (Quick-Trigger). Table 2 shows the coating compositions used for the tests. The acrylic resin used in the tests was a white, pure acrylic polymer (i.e., a polymer or copolymer derived exclusively from acrylate monomers) containing about 55% by weight solids, and having a T_{g} of −28° C. when applied to a surface as a film. The weight percentages of the acrylic resin, water, volatile base, filler, pigment, biocide, and additives (including defoamer, plasticizer, rheology modifier, coalescing agent, dispersants, extender) were held constant, while the weight percentage of the curing agent and the presence or absence of the odor mitigator were varied (see Table 2). The coating compositions were tested for: 1) skin formation time (or film formation time) under three different temperature conditions (40° F., 75° F., and 100° F.) at ambient pressure, 2) full film curing time under three different temperature conditions (40° F., 75° F., and 100° F.) at ambient pressure, 3) ammonia odor rating, 4) early rain resistance, and 5) shelf life.

TABLE 2
Coating Compositions Used for Tests

| Ingredient | % by weight |
|---|---|
| acrylic resin | approx. 37% |
| water | approx. 13% |
| curing agent | Varied |
| odor mitigator | varied (0% or |
| | approx. 0.19%) |
| volatile base (aqua ammonia) | approx. 2.4% |
| fillers and pigments (calcium carbonate, | approx. 40% |
| titanium dioxide) | |
| additives (paraffin, propylene glycol, | approx. 2.5% |
| cellulose, Texanol ester alcohol, | |
| potassium tripolyphosphate, | |
| polycarboxylate, kaolin clay) | |
| biocides | approx. 0.67% |

Ammonia Odor Rating: To determine ammonia odor rating, the coating compositions were assessed by a few individuals for an ammonia odor by smell in a can prior to curing. The coating compositions were assigned a value from 1 to 5 depending on the detected strength of the ammonia odor, with 1 being a very strong ammonia odor, 2 being a strong odor, 3 being little odor, 4 being very little odor, and 5 being no odor.

Film Formation Time: To determine film (or skin) formation time, the coating compositions were manually tested periodically under three different temperature conditions (40° F., 75° F., and 100° F.) at ambient pressure. The film formation time is defined herein as the time that it took for the applied coating compositions to harden to a state where it is still dentable, but does not come up on a finger or glove when touched manually. Film formation was tested at 2 gallons/square (where 1 square is 100 square feet), or at a coating thickness of approximately 32 mils.

Full Film Cure Time: To determine full film cure times, the coating compositions were tested periodically under three different temperature conditions (40° F., 75° F., and 100° F.) at ambient pressure for complete curing. The full film cure time is defined herein as the time that it took for the applied coating composition to harden to a fully cured state that is not easily dentable or malleable.

Early Rain Resistance Measurements: To measure early rain resistance, the coating compositions were applied to a surface at a thickness of about 10 mils (about 0.25 millimeters), and were allowed to cure at a set time under a fixed temperature and a fixed humidity level. The curing conditions tested were: 1-90° F./20% relative humidity with a 2 hour cure time, 2-70° F./50% relative humidity with a 1 hour cure time, 3-90° F./80% relative humidity with a 30 minute cure time, and 4-40° F./80% relative humidity with a 30 minute cure time, with curing condition 1 being the easiest curing condition and curing condition 4 being the most challenging curing condition. Following curing, the coating compositions were each placed under a shower head for 5-20 min and exposed to a water flowrate of 2 gallons/minute at a water pressure of 45 psi to simulate rainfall conditions. If the coating did not wash off, the coating composition passed the test for that curing condition. If any of the coating washed off, the coating composition failed the test for that curing condition. Each coating composition was assigned a score for early rain resistance corresponding to the most challenging curing condition that the coating composition passed, with 1 indicating low early rain resistance and 4 indicating high early rain resistance. If, for example, the coating composition was assigned an early rain resistance score of 3, the coating composition did not wash off after curing under curing conditions 1-3, but did wash off after curing under curing condition 4. Likewise, if the coating composition was assigned a value of 4 for early rain resistance, the coating composition did not wash off after curing under any of the curing conditions 1-4. A score of 0 indicates that the coating composition did not pass the test under any curing condition. That is, the coating composition washed off after curing under all curing conditions 1-4.

Table 3 shows test results for film formation time, ammonia odor rating, early rain resistance, and shelf life for coating compositions lacking the neutral type fragrance odor mitigator with varying weight percentages of the Quick-Trigger curing agent.

TABLE 3
Test results for Coating Compositions without the Odor Mitigator^{a}

| | | Film | Film | Film | | | |
|---|---|---|---|---|---|---|---|
| Curing | Odor | formation | formation | formation | | | Shelf |
| agent, | mitigator, | time | time | time | Odor | Early rain | life, |
| wt % | wt % | (40° F.), hrs | (75° F.), hrs | (100° F.), hrs | rating | resistance | months |
| 0.6 | 0 | 61 | 13 | 7 | 1 | 3 | 6 |
| 1 | 0 | 38 | 11 | 4.5 | 1 | 4 | 3^{b} |
| 2 | 0 | 23 | 8 | 2.5 | 1 | 4 | 2^{b} |
| 3 | 0 | 32 | 6.5 | 2 | 1 | 4 | 1^{b} |
| 4 | 0 | 16 | 6^{b} | 2^{b} | 1 | 4 | >1 |

^{a}Coatings were applied at a coverage of 2 gallons/square, where 1 square = 100 square feet. Films were created using a drawdown bar from Paul N. Gardner, a BYK Instruments Company.
^{b}Implied or expected value determined based on extrapolation of experimental data to longer time points.

Table 4 shows test results for film formation time, ammonia odor rating, early rain resistance, and shelf life for coating compositions that include the neutral type fragrance odor mitigator with varying concentrations of the curing agent.

TABLE 4
Test results for Coating Compositions with the Odor Mitigator^{a}

| | | Film | Film | Film | | | |
|---|---|---|---|---|---|---|---|
| Curing | Odor | formation | formation | formation | | | Shelf |
| agent, | mitigator, | time | time | time | Odor | Early rain | life, |
| wt % | wt % | (40° F.), hrs | (75° F.), hrs | (100° F.), hrs | rating | resistance | months |
| 0.6 | 0.2 | 62 | 15 | 8 | 4 | 2^{b} | 24^{b} |
| 1 | 0.2 | 36 | 13 | 5.5 | 4 | 3^{b} | 12^{b} |
| 2 | 0.2 | 25 | 11 | 3.5 | 4 | 3^{b} | 10^{b} |
| 3 | 0.2 | 20 | 8 | 2.25 | 4 | 4 | 8^{b} |
| 4 | 0.2 | 16 | 5 | 2.25 | 4 | 4 | 6 |

^{a}Coatings were applied at a coverage of 2 gallons/square, where 1 square = 100 square feet. Films were created using a drawdown bar from Paul N. Gardner, a BYK Instruments Company.
^{b}Implied or expected value based on extrapolation of experimental data to longer time points.

Tables 5-6 show test results for full film cure time, ammonia odor rating, early rain resistance, and shelf life for coating compositions lacking the neutral type fragrance odor mitigator (Table 5) and for coating compositions having the neutral type fragrance odor mitigator (Table 6), each with varying concentrations of the curing agent.

TABLE 5
Test results for Coating Compositions without the Odor Mitigator^{a}

| Curing | Odor | Full film | Full film | Full film | | | Shelf |
|---|---|---|---|---|---|---|---|
| agent, | mitigator, | cure time | cure time | cure time | Odor | Early rain | life, |
| wt % | wt % | (40° F.), hrs | (75° F.), hrs | (100° F.), hrs | rating | resistance | months |
| 0.6 | 0 | 210 | 109 | 70 | 1 | 3 | 6 |
| 1 | 0 | 186 | 101 | 64 | 1 | 4 | 3 |
| 2 | 0 | 205 | 95 | 62 | 1 | 4 | 2 |
| 3 | 0 | 200 | 91 | 60 | 1 | 4 | 1 |
| 4 | 0 | 180 | 85^{b} | 56^{b} | 1 | 4 | >1 |

^{a}Coatings were applied at a coverage of 2 gallons/square, where 1 square = 100 square feet. Films were created using a drawdown bar from Paul N. Gardner, a BYK Instruments Company.
^{b}Implied or expected value based on extrapolation of experimental data to longer time points.

TABLE 6
Test results for Coating Compositions with the Odor Mitigator^{a}

| Curing | Odor | Full film | Full film | Full film | | | Shelf |
|---|---|---|---|---|---|---|---|
| agent, | mitigator, | cure time | cure time | cure time | Odor | Early rain | life, |
| wt % | wt % | (40° F.), hrs | (75° F.), hrs | (100° F.), hrs | rating | resistance | months |
| 0.6 | 0.2 | 225 | 109, 115^{c} | 60 | 4 | 2^{b} | 24^{b} |
| 1 | 0.2 | 170 | 111, 108^{c} | 55 | 4 | 3^{b} | 12^{b} |
| 2 | 0.2 | 160 | 120, 101^{c} | 66, 57^{c} | 4 | 3^{b} | 10^{b} |
| 3 | 0.2 | 155 | 100, 79^{c} | 63, 54^{c} | 4 | 4 | 8^{b} |
| 4 | 0.2 | 160, 155^{c} | 97 | 52, 54^{c} | 4 | 4 | 6 |

^{a}Coatings were applied at a coverage of 2 gallons/square, where 1 square = 100 square feet. Films were created using a drawdown bar from Paul N. Gardner, a BYK Instruments Company.
^{b}Implied or expected value based on extrapolation of experimental data to longer time points.
^{c}Repeated experimental data set with each value representing the result of a separate experiment.

Referring to Tables 3 and 5 (without odor mitigator), increasing amounts of the curing agent reduced both film (or skin) formation and full film cure times under all three temperature conditions tested. Additionally, the curing agent provided high early rain resistance scores (3-4) in all of the coating compositions tested. However, the coating compositions produced very strong odors (odor ratings of 1) in the absence of the odor mitigator, and had shelf lives of six months or less. Shelf lives decreased with increasing amounts of the curing agent. For instance, with 4% by weight of the curing agent without the odor mitigator, the shelf life was less than one month.

Referring to Tables 4 and 6, the presence of the neutral type fragrance odor mitigator resulted in a significant improvement in the odor rating. All coating compositions that included the odor mitigator produced very little odor (odor rating of 4). Notably, the shelf lives of the coating compositions were extended substantially in the presence of the odor mitigator. For instance, the shelf life of the coating composition with 4% by weight curing agent was extended to 6 months with the addition of the odor mitigator. Accordingly, the shelf life of the coating composition was increased by more than six times in the presence of the odor mitigator. This is an unexpected improvement in the coating composition properties resulting from the addition of the odor mitigator.

Early rain resistance scores appeared to decrease in the presence of the odor mitigator in the coating compositions having lower weight percentages (2% by weight or less) of the curing agent, suggesting that the odor mitigator may counteract the influence of the curing agent somewhat (compare Tables 3 and 4, and Tables 5 and 6). This may be explained by slightly longer film formation times and full cure times observed in some of the coating compositions having odor mitigator and 2% by weight or less of the curing agent (compare Tables 3 and 4, and Tables 5 and 6). At curing agent concentrations of 3-4% by weight, however, early rain resistance scores were not impacted by the presence of the odor mitigator (compare Tables 3 and 4, and Tables 5 and 6). Thus, as shown herein, tuning the relative contents of the odor mitigator and the curing agent may counteract or rectify any negative impacts of the odor mitigator on early rain resistance properties.

In view of the foregoing, it can be seen that the surface coating compositions of the present disclosure provide a combination of several benefits including fast curing times, early rain resistance, and reduced odors. Namely, Applicant has discovered an odor mitigator that reduces unpleasant odors in acrylic-based coating formulations that include derivatized polyamine-based curing agents. Notably, unexpected improvements in shelf life were also observed in the presence of the odor mitigator. When relative concentrations of the curing agent and the odor mitigator are appropriately adjusted, the odor mitigator does not influence the catalytic activity of the curing agent. The combination of the properties of the coating compositions of the present disclosure may improve conditions for work crew and/or building occupants during a coating application process, improve storage and handling, and facilitate coating applications in unfavorable weather conditions.

What is claimed is:

1. A coating composition for coating a surface, comprising:
an acrylic polymer;
water;
a volatile base producing an odor;
a curing agent configured to reduce a curing time for the coating composition when applied to the surface; and
an odor mitigator configured to reduce an odor of the coating composition resulting from the volatile base.

2. The coating composition of claim 1, wherein the odor mitigator comprises a mixture of hydrocarbons, esters, alcohols, and aldehydes.

3. The coating composition of claim 1, wherein the odor mitigator comprises a blend of eucalyptus oil, 3-phenyl-2-propenal, (1S, 5S)-2,6,6-trimethylbicyclo[3.1.1]hept-2-ene, cymbopogon nardus oil, α,α,4-trimethyl-3-cyclohexene-1-methanol, 2H-1-benzopyran-2-one, and 4,5,6-trimethylcyclohex-3-ene-1-carbaldehyde.

4. The coating composition of claim 3, wherein the volatile base is ammonia.

5. The coating composition of claim 4, wherein the coating composition comprises from about 0.1% to about 0.5% by weight of the odor mitigator.

6. The coating composition of claim 5, wherein the coating composition comprises about 0.2% by weight of the odor mitigator.

7. The coating composition of claim 6, wherein the curing agent comprises one or more derivatized polyamines having one or more amine groups derivatized with a non-hydrogen moiety (R).

8. The coating composition of claim 7, wherein the one or more derivatized polyamines include a derivatized polyalkylene imine or an alkoxylated polyvinylamine.

9. The coating composition of claim 7, wherein the coating composition includes from about 0.5% to about 5% by weight of the curing agent.

10. The coating composition of claim 9, wherein the coating composition includes about 4% by weight of the curing agent.

11. A coating composition for coating a surface, comprising:
an acrylic resin;
water;
ammonia;
from about 0.5% to about 5% by weight of a curing agent configured to reduce a curing time for the coating composition, the curing agent comprising one or more derivatized polyamines derivatized with a non-hydrogen moiety (R); and
an odor mitigator configured to reduce an odor of the coating composition.

12. The coating composition of claim 11, wherein the derivatized polyamine has a degree of derivatization of at least 40%.

13. The coating composition of claim 12, wherein the derivatized polyamine includes a derivatized polyalkylene imine or an alkoxylated polyvinylamine.

14. The coating composition of claim 12, wherein the coating composition comprises about 4% by weight of the curing agent.

15. The coating composition of claim 14, wherein the odor mitigator comprises a blend of eucalyptus oil, 3-phenyl-2-propenal, (1S, 5S)-2,6,6-trimethylbicyclo[3.1.1]hept-2-ene, cymbopogon nardus oil, α,α,4-trimethyl-3-cyclohexene-1-methanol, 2H-1-benzopyran-2-one, and 4,5,6-trimethylcyclohex-3-ene-1-carbaldehyde.

16. The coating composition of claim 15, wherein the coating composition comprises about 0.2% by weight of the odor mitigator.

17. The coating composition of claim 16, further comprising fillers and pigments, and one or more additives selected from defoamers, plasticizers, coalescents, surfactants, rheology modifiers, co-solvents, and biocides.

18. A method of formulating a surface coating composition, comprising:
formulating a base coating composition at least including an acrylic-based resin and water;
adjusting a pH of the base coating composition to above 10.8 by adding and mixing aqueous ammonia into the base coating composition;
adding and mixing from about 0.5% to about 5% by weight of a curing agent into the base coating composition after adjusting the pH of the base coating composition, the curing agent being configured to reduce a curing time for the coating composition when applied to a surface, the curing agent including one or more derivatized polyamines having one or more amine groups derivatized with a non-hydrogen moiety (R); and
adding and mixing an odor mitigator into the base coating composition to provide the surface coating composition, the odor mitigator being configured to reduce an odor of the surface coating composition.

19. The method of claim 18, wherein adding and mixing the odor mitigator into the base coating comprises adding and mixing a blend of eucalyptus oil, 3-phenyl-2-propenal, (1S, 5S)-2,6,6-trimethylbicyclo[3.1.1]hept-2-ene, cymbopogon nardus oil, α,α,4-trimethyl-3-cyclohexene-1-methanol, 2H-1-benzopyran-2-one, and 4,5,6-trimethylcyclohex-3-ene-1-carbaldehyde into the base coating composition.

20. The method of claim 19, wherein:
adding and mixing the curing agent into the base coating composition comprises adding and mixing about 4% by weight of the curing agent into the base coating composition; and
adding and mixing the odor mitigator into the base coating composition comprises adding and mixing about 0.2% by weight of the odor mitigator into the base coating composition.
